(19) United States
(12) Patent Application Publication
(10) Pub. No.: US 2013/0305033 A1
(43) Pub. Date: Nov. 14, 2013

(54) DATA ENCRYPTION METHOD

(71) Applicants: Francis Gerard Lacson, Seattle, WA (US); Thomas William Corddry, Seattle, WA (US); John William Kucher, Seattle, WA (US)

(72) Inventors: Francis Gerard Lacson, Seattle, WA (US); Thomas William Corddry, Seattle, WA (US); John William Kucher, Seattle, WA (US)

(21) Appl. No.: 13/638,570

(22) PCT Filed: Feb. 1, 2012
(86) PCT No.: PCT/US2012/023538

§ 371 Date: Dec. 10, 2012

Related U.S. Application Data
(60) Provisional application No. 61/438,628, filed on Feb. 1, 2011.

(51) Int. Cl. H04L 29/06

(52) U.S. Cl. CPC H04L 63/0428
USPC 713/150

(57) ABSTRACT

A method performed by a computing system. Embodiments of the method include shifting source data by a shift amount and encrypting the shifted data with an encryption key to produce encrypted data. An encryption package is produced by removing a portion of the encrypted data. Decryption data is generated that includes the shift amount, the encryption key, the location in the encrypted data from which the data was removed, and the data that was removed. Copies of the encryption package are sent to remote client computing devices and the system waits until a decryption time. At the decryption time, copies of the decryption data are sent to the client computing devices, which are each configured to decrypt the encryption package using the decryption data to obtain the information of the source data at substantially the same time.

### CROSS REFERENCE TO RELATED APPLICATION(S)

This application claims the benefit of U.S. Provisional Application No. 61/438,628, filed Feb. 1, 2011, which is incorporated herein by reference in its entirety.

### BACKGROUND OF THE INVENTION

1. Field of the Invention

The present invention is directed generally to methods of encrypting and decrypting data.

2. Description of the Related Art

Sending data across a network to a plurality of recipients such that each recipient receives the data at the same time is difficult because networks are typically constructed from heterogeneous hardware and software components. Further, the data must travel further to reach some recipient than others. In other words, the distance traveled by the data to each recipient is not identical. Thus, different amounts of time may elapse between the sending of the data by a sender and the receipt of the data by each of a plurality of recipients. This latency is particularly problematic when a large amount of data is sent over the network.

For a plurality of users to play a game simultaneously, the users must have access to identical data at substantially the same time. For example, to play a game in which users respond to questions within a predetermined amount of time, the users must be provided with the questions at substantially the same time. If some users have access to the questions before other users, the users with the earlier access will have an unfair advantage over the users with later access to the questions. Further, the users must be presented with a question at substantially the same time when playing a game in which the order responses are received determines who wins with respect to the question (e.g., the user who provided the first correct response to the question is the winner).

Therefore, a need exists for methods of sending data to a plurality of recipients such that each of the recipients has access to the data at substantially the same time. Methods that prevent recipients from gaining early access to the data are particularly desirable. The present application provides these and other advantages as will be apparent from the following detailed description and accompanying figures.

### SUMMARY OF THE INVENTION

Embodiments of the invention include a method for use with source data. The method includes shifting the source data in a shift direction by a shift amount (e.g., a number of bytes) to produce shifted source data, encrypting (e.g., using RC4 encryption) the shifted source data with an encryption key to produce encrypted shifted source data, and removing a portion of data from a location in the encrypted shifted source data to produce an encryption package. Optionally, the encryption key may have a variable length. For example, the length of the encryption key may vary from 20 bytes to 256 bytes. By way of another example, the length of the encryption key may vary from 20 bytes to 32 bytes. In some embodiments, the encryption package is stored in a file including fewer than 10 megabytes.

The method further includes generating decryption data including the shift amount, the encryption key, an identification of the location in the encrypted shifted source data from which the portion of the data was removed, and the portion of the data removed from the encrypted shifted source data. The decryption data may include fewer than 256 bytes. In some embodiments, the decryption data includes 35 bytes to 84 bytes. In some embodiments, the decryption data further includes a length of the encryption key, and/or a length of the portion of the data removed from the encrypted shifted source data.

A copy of the encryption package may be sent to each of a plurality of remote client computing devices. After the copies of the encryption package have been sent to the client computing devices, the method may include waiting until a decryption time before sending a copy of the decryption data to each of the plurality of remote client computing devices. Each of the plurality of remote client computing devices may be configured to decrypt the copy of the encryption package using the copy of the decryption data received by the client computing device. Further, the copy of the decryption data may be sent to each of the plurality of remote client computing devices at substantially the same time such that the plurality of remote client computing devices have the opportunity to decrypt the copies of the encryption package at substantially the same time.

The shift amount and/or the location in the encrypted shifted source data from which the portion of the data is removed may be selected using a random or pseudo-random process configured to select a number within a predetermined range. Further, the portion of the data removed from the encrypted shifted source data may include a number of bytes that are selected using a random or pseudo-random process configured to select a number within a predetermined range.

Optionally, the source data may be compressed before it is shifted. Also optionally, the source data may be arranged into a byte array before the source data is shifted. In such embodiments, the shifted source data is produced by shifting the source data arranged in the byte array. Optionally, the byte array may be compressed before the source data is shifted. In such embodiments, the decryption data further includes a flag indicating whether the byte array was compressed; and a value is stored in the flag indicating the byte array was compressed.

Some embodiments include a method performed by at least one server computing device connected to a plurality of client computing devices by at least one network. The method includes sending a copy of an encrypted data file to each of the plurality of client computing devices over the at least one network. After the copies of the encrypted data file are sent, the at least one server computing device waits until a predetermined time. At the predetermined time, the at least one server computing device sends decryption data to each of the plurality of client computing devices over the at least one network. The decryption data is configured to be received by the plurality of client computing devices at substantially the same time, and includes information usable by each of the plurality of client computing devices to decrypt the copy of the encrypted data file sent to the client computing device. Optionally, the information includes a shift amount, an encryption key, an identification of a location from which a portion of the data was removed from the copies of the encrypted data file, and the portion of the data that was removed. In some embodiments, the copies of the encrypted data file each include a plurality of questions. In such embodiments, the method further includes receiving responses to the plurality of questions after sending the decryption data to each of the plurality of client computing devices.

Some embodiments include a method for use with a source file including bytes of data. The method includes placing the bytes of data of the source file in a byte array and compressing the bytes in the byte array to produce a compressed byte array. The bytes of data in the compressed byte array are shifted in a shift direction by a shift amount to produce a shifted byte array, which is encrypted with an encryption key to produce an encrypted byte array. A portion of the encrypted byte array is removed to produce an incomplete byte array. The incomplete byte array is stored as an encryption package. Decryption data is also stored. The decryption data includes the shift amount, the encryption key, an identification of the location in the encrypted byte array from which the portion was removed, and the portion removed from the encrypted byte array. Optionally, the decryption data also includes a length of the portion removed from the encrypted byte array and/or a length of the encryption key. In some embodiments, the decryption data includes a flag indicating whether the bytes of data in the byte array were compressed, and the method further includes storing a value in the flag indicating the bytes of data in the byte array were compressed.

Other embodiments include a computing system including at least one server computing device connected to a plurality of remote client computing devices. The at least one server computing device is configured to shift source data (including information) in a shift direction by a shift amount to produce shifted source data, and encrypt the shifted source data with an encryption key to produce encrypted shifted source data. The server computing device is further configured to remove a portion of the data from a location in the encrypted shifted source data to produce an encryption package. The server computing device is also configured to generate decryption data including the shift amount, the encryption key, an identification of the location in the encrypted shifted source data from which the portion of the data was removed, and the portion of the data removed from the encrypted shifted source data. The server computing device sends a copy of the encryption package to each of the plurality of remote client computing devices and sends a copy of the decryption data to each of the plurality of remote client computing devices at a decryption time occurring after the copies of the encryption package are sent to the plurality of remote client computing devices. Each of the remote client computing devices is configured to decrypt the copy of the encryption package using the copy of the decryption data received by the client computing device to substantially simultaneously obtain the information of the source data. The at least one server computing device may be further configured to receive responses from the plurality of remote client computing devices.

### BRIEF DESCRIPTION OF THE SEVERAL VIEWS OF THE DRAWING(S)

FIG. 1 is a diagram illustrating a system that includes a server computing device connected to a plurality of client computing devices by at least one network.

FIG. 2 is a block diagram illustrating data and programming modules stored in a system memory of the server computing device of FIG. 1.

FIG. 3 is a flow diagram of a method performed by an encryption module stored in the system memory illustrated in FIG. 2.

FIG. 4 is an illustration of an example of a format that may be used to store decryption data (“DD”).

FIG. 5 is a block diagram illustrating data and programming modules stored in a system memory of each of the plurality of client computing devices of FIG. 1.

FIG. 6 is a flow diagram of a method performed by the server computing device of FIG. 1.

FIG. 7 is a flow diagram of a method performed by each of the plurality of client computing devices of FIG. 1.

FIG. 8 is a diagram of a hardware environment and an operating environment in which the server computing device, each of the plurality of client computing devices, and the at least one network of the system of FIG. 1 may be implemented.

### DETAILED DESCRIPTION OF THE INVENTION

A sender may send data to a plurality of recipients in three phases. In a first phase, the sender sends data to the recipients in an encrypted format that the recipients cannot readily decrypt. Then, in a second phase, the sender waits a sufficient amount of time for the recipients to receive the encrypted data. In a third phase, the sender sends decryption information to the recipients that the recipients may use to decrypt the encrypted data to thereby gain access to the data. The decryption information is configured to arrive at recipients at substantially identical times. The encrypted data is encrypted such that it cannot be decrypted without the decryption information in an amount of time between the receipt of the encrypted data and the arrival of the decryption information.

By performing the above three phases, the sender restricts access to the encrypted data until after the decryption information is received. Because the decryption information is configured to arrive at the recipients at substantially the same time, the recipients may use the decryption data to obtain substantially simultaneous access to the data. Even if the encrypted data is large enough such that non-uniform network latencies cause the encrypted data to arrive at the recipients at different times, provided each of the recipients receive the encrypted data before the decryption information, the non-uniform arrival times of the encrypted data will not provide earlier access to the data to some recipients than to other recipients.

For example, the sender may be an online game provider. In such an embodiment, the encrypted data may include questions and corresponding answer choices for a game to be sent to a plurality of recipients (or players). Before the game is to begin, the game provider sends the encrypted data to the players and waits a sufficient amount of time (e.g., 10 minutes) for the players to receive the encrypted data (e.g., questions). Then, to begin playing the game, the game provider sends the decryption information to the players, who receive the decryption information substantially simultaneously, use the decryption information to decrypt the encrypted data (e.g., questions), and begin playing the game.

The game may be broadcast live and displayed on players' television sets. The players may play the game by using a personal computer (e.g., a laptop computer, tablet personal computer, and the like), personal digital assistant, cellular telephone (e.g., a smartphone), or the like while watching the game on a television set. Further, a web or Internet enabled television set may display the game as well as provide a means by which the game may be played over the Internet. An Internet enabled television may include hardware and software components necessary to connect to the Internet (e.g., displaying web pages). Alternatively, a conventional television may become Internet enabled by connecting the conventional television to an external device (e.g., a set-top box) configured to connect to the Internet and use the conventional television as a display device.

By way of another non-limiting example, the sender may be an entity engaged in military operations, financial management, politics, journalism, public relations, business, education, and the like. The encrypted data may include any data (e.g., actionable data) communicated by an entity to one or more recipients. For example, the encrypted data may include a press release sent by the sender (e.g., a government entity, celebrity, public relations company, business, and the like) to media companies (recipients). Before the press release is to be released to the public, the sender sends the encrypted data including the press release to the media companies and waits a sufficient amount of time for the media companies to receive the encrypted data. Then, when the press release is to be released to the public, the sender sends the decryption information to the media companies, who receive the decryption information substantially simultaneously, use the decryption information to decrypt the encrypted data, and release the press release to the public.

By way of another example, the encrypted data may include quiz or test questions sent by the sender (e.g., a teacher, professor, and the like) to student recipients.

By way of another example, the encrypted data may include financial data of the type sent by subscription services to hedge fund managers, financial services firms, and the like. The financial data is typically analyzed automatically, and earlier access to the financial data by one or more firms provides such firms with an unfair advantage over other firms with later access.

By way of another example, the encrypted data may include polling questions sent by a polling firm to viewers simultaneously viewing an event (e.g., a state of the union speech). The polling questions could be used to capture opinions at very precise points in time by distributing one or more polling questions in the encrypted data before each particular point in time and then sending the decryption data to decrypt the polling question(s) immediately before the particular point in time.

By way of another example, the encrypted data may include battlefield communications. For example, if a military operation is being conducted by two or more allies against a common foe, surprise is an important element of the operation, and some members of the alliance are of uncertain reliability (e.g., have close ties to the foe), distribution of orders by current means includes at least some risk that the orders might be passed to the foe. However, this risk may be reduced by distributing the orders in the encrypted data and waiting to send the decryption data until the moment the orders are to be acted upon.

By way of another example, the sender may send more than one item of encrypted data (each including a set of instructions) to each of the recipients. For example, alternate sets of instructions may be sent to each of the recipients. Then, the sender sends only the decryption data for the encrypted data including the set of instructions to be followed to each of the recipients. For example, a command unit may send more than one item of encrypted data (each including orders) to each of a plurality of units in the field. Then, at a later time, the command unit sends only the decryption data for the encrypted data including orders to be followed by the units in the field.

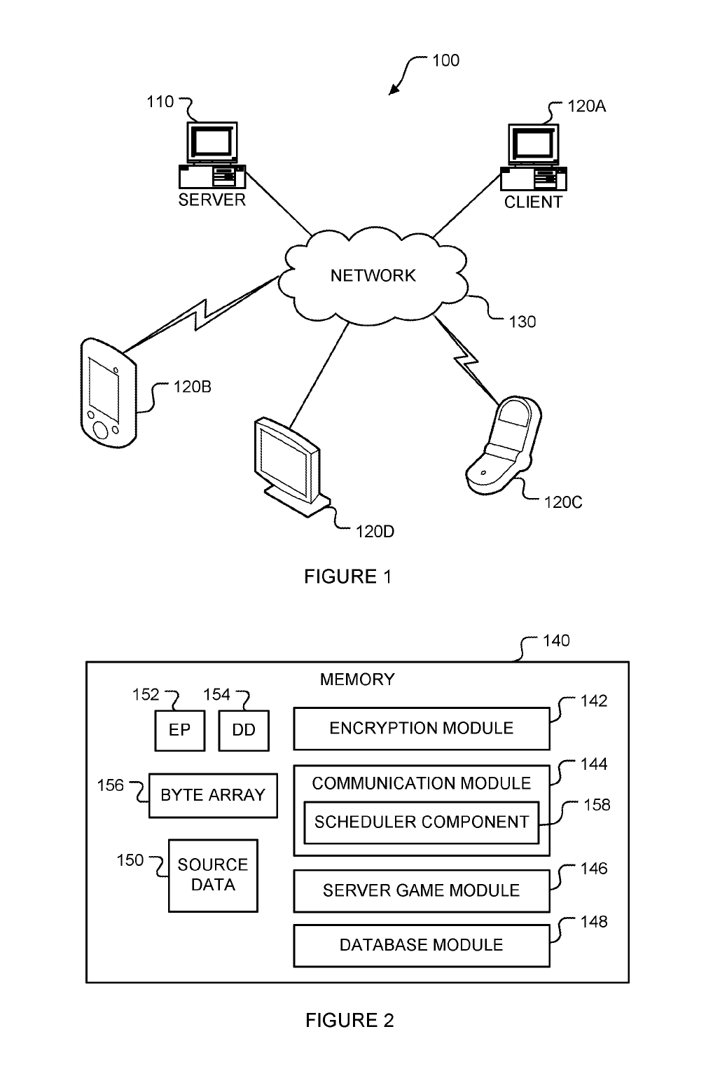

FIG. 1 is an illustration of a system 100. The system 100 includes a server computing device 110 connected to a plurality of client computing devices 120A, 120B, 120C, and 120D by a network 130. While the server computing device 110 is illustrated as being connected to the four client computing client computing devices 120A, 120B, 120C, and 120D, those of ordinary skill in the art appreciate that the server computing device 110 may be connected to any number of client computing devices and the server computing device 110 is not limited to use with any particular number of client computing devices. The server computing device 110 is operated by a sender of the encrypted data and the decryption information. By way of non-limiting examples, in FIG. 1, the client computing device 120A is illustrated as a personal computer (e.g., a laptop, tablet personal computer, and the like), the client computing device 120B is illustrated as a personal digital assistant, the client computing device 120C is illustrated as a cellular telephone, and the client computing device 120D is illustrated as an Internet enabled television. Each of the client computing devices 120A, 120B, 120C, and 120D is operated by a recipient of the encrypted data and the decryption information. One or more of the client computing devices 120A, 120B, 120C, and 120D may be located remotely from the server computing device 110.

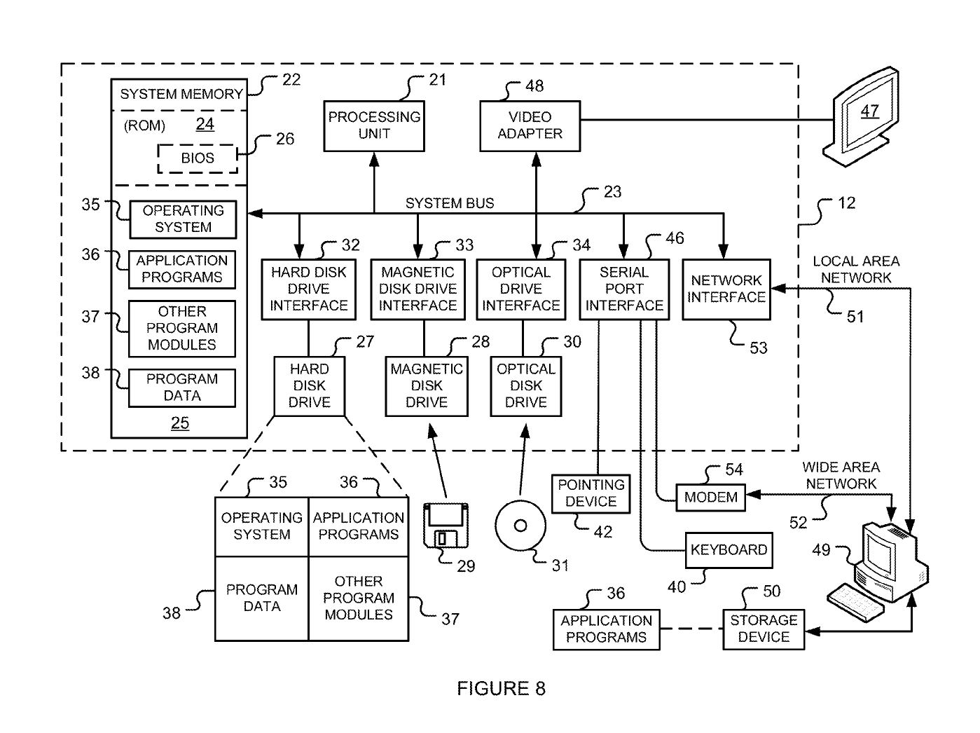

A diagram of hardware and an operating environment in conjunction with which implementations of the server computing device 110, the plurality of client computing devices 120A, 120B, 120C, and 120D, and the network 130 may be practiced is provided in FIG. 8 and described below.

Referring to FIG. 2, as will be described in more detail below, the server computing device 110 includes a system memory 140 storing data and programming modules. The programming modules each include instructions executable by one or more processors (e.g., a processing unit 21 illustrated in FIG. 8 and described below). The programming modules illustrated in FIG. 2 include an encryption module 142, a communication module 144, a server game module 146, and a database module 148. The data includes source data 150, which may have been generated by the server computing device 110. The source data 150 may be stored as a file in the system memory 140. However, this is not a requirement and embodiments in which the source data 150 is stored as a data structure in volatile memory (e.g., random access memory 25 illustrated in FIG. 8) are with the scope of the present teachings.

The encryption module 142 includes instructions that when executed by one or more processors generate an encryption package (“EP”) 152 and decryption data (“DD”) 154 from the source data 150. The EP 152 includes an encrypted version of the source data 150. Optionally, the EP 152 may also be compressed. However, this is not a requirement. The DD 154 includes decryption information (e.g., a decryption key). The DD 154 may be configured to be small enough to be sent quickly over low-bandwidth connections. By way of a non-limiting example, the DD 154 may be about 35 bytes to about 256 bytes. By way of another non-limiting example, the DD 154 may be about 35 bytes to about 84 bytes. The size of the DD 154 may depend at least in part on the length of the decryption key.

Each of the EP 152 and/or the DD 154 may be stored as a file in the system memory 140. However, this is not a requirement and embodiments in which each of the EP 152 and/or the DD 154 is stored as a data structure in volatile memory (e.g., the random access memory 25 illustrated in FIG. 8) are with the scope of the present teachings. By way of yet another non-limiting example, each of the EP 152 and/or the DD 154 may be stored in one or more records in a database implemented by the database module 148.

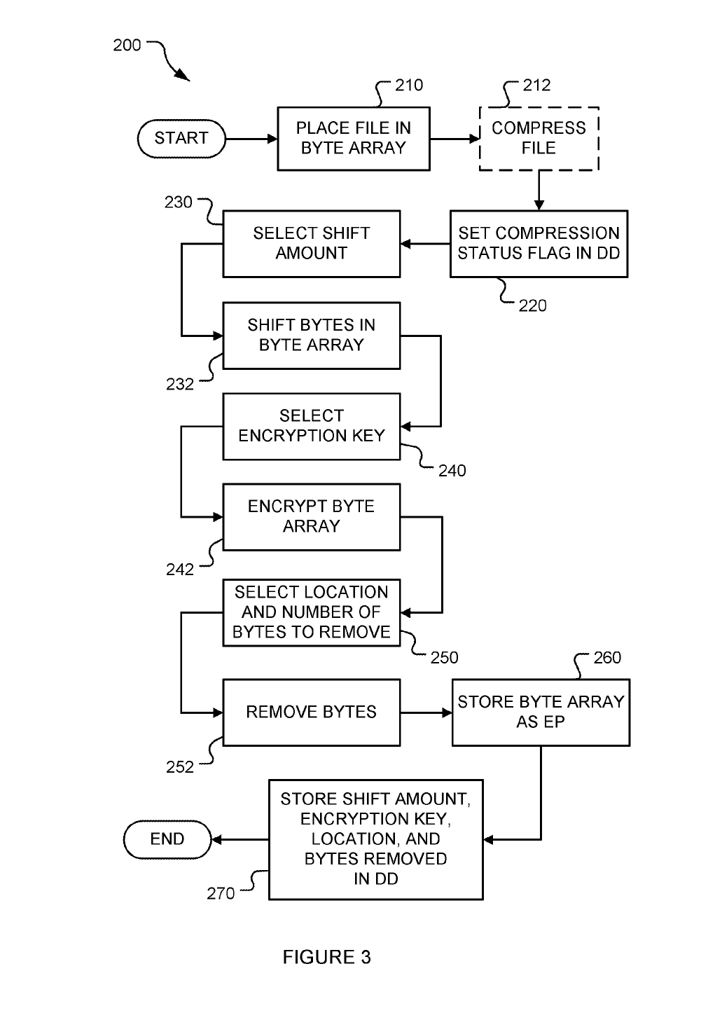

FIG. 3 is a flow diagram of a method 200 that may be performed by the encryption module 142. In first block 210, the source data 150 (see FIG. 2) is read and placed into a group of bytes or a byte array 156 (see FIG. 2). Then, in optional block 212, the byte array 156 is compressed. In block 220, an optional compression status flag in the DD 154 may be set indicating whether the byte array 156 was compressed in optional block 212. The compression status flag may be implemented as a bit field having a size of one byte.

In block 230, a shift amount is selected. The shift amount indicates a number of bytes by which the byte array 156 is to be shifted in a predetermined shift direction. The shift amount may be selected randomly or pseudo-randomly using any method suitable for randomly or pseudo-randomly selecting a number within a predetermined range. By way of a non-limiting example, the predetermined range may be one byte to 254 bytes. By way of a non-limiting example, the shift amount may be generated or selected based on a number obtained using GetBytes method of a System.Security.Cryptography.RNGCryptoServiceProvider class provided by a .NET platform available from Microsoft Corporation. By way of another example, the shift amount may be generated or selected based on a number obtained using a function named “random( )” of a Javascript or ActionScript object named “Math.” Alternatively, the shift amount may be generated or selected based on a number obtained using a service, such as Random Integer Generator provided on a website operated at “http://www.random.org/integers/?mode=advanced” by Dr. Mads Haahr. In such an implementation, a wrapper may be created for the function provided by the service. Further, the shift amount may be generated or selected based on the numbers obtained from two or more of the techniques described above. By way of another example, the shift amount may be generated or selected based on the number(s) obtained from one or more of the techniques described above and another value, such as a value obtained from a high resolution timer of the server computing device 110. Further, the shift amount may be generated or selected by performing a function on the number(s) obtained from one or more of the techniques described above. For example, every x^{th} digit may be deleted from a number obtained from one of the techniques described above.

In block 232, the bytes in the byte array 156 are shifted by the shift amount.

In block 240, an encryption key is selected. The encryption key may have a variable length. Depending upon the implementation details, the encryption key may have a length of about 20 bytes to about 256 bytes. In particular embodiments, the encryption key may have a length of about 20 bytes to about 32 bytes. In other words, the length of the encryption key may not be constant. For example, the length of the encryption key may be selected randomly or pseudo-randomly using any method suitable for randomly or pseudo-randomly selecting a number within a predetermined range. Any of the methods described above with respect to generating or selecting the shift amount may be used to generate or select the length of the encryption key. By way of a non-limiting example, the length of the encryption key may be determined based on the shifted source data. By way of yet another non-limiting example, the encryption key may be selected in accordance with a conventional RC4 encryption methodology.

In block 242, the bytes in the byte array 156 are encrypted using the encryption key. By way of a non-limiting example, the byte array 156 may be encrypted using conventional RC4 encryption. However, another encryption methodology may be used. In some embodiments, an encryption method may be selected from a plurality of encryption methods. In such embodiments, one or more of the bits in the bit field used to implement the compression status flag may be used to specify the encryption method used.

In block 250, a location in the byte array 156 and a number of bytes to remove are selected. The location selected may be a start location from which the number of bytes is removed. The location and number of bytes may each be selected randomly or pseudo-randomly using any method suitable for randomly or pseudo-randomly selecting a random number within a predetermined range. By way of a non-limiting example, the number of bytes to remove may be selected from the predetermined range of about 8 bytes to about 256 bytes. By way of another non-limiting example, the number of bytes to remove may be selected from the predetermined range of about 8 bytes to about 16 bytes. The location may be selected from the predetermined range starting with the first byte in the byte array 156 and ending a predetermined number of bytes before the end of the byte array 156. The predetermined number of bytes before the end of the byte array 156 may be the number of bytes selected for removal from the byte array 156. Alternatively, the predetermined number of bytes before the end of the byte array 156 may be the maximum value (e.g., 16 bytes or 256 bytes) of the predetermined range from which the number of bytes to remove is selected. Any of the methods described above with respect to generating or selecting the shift amount may be used to generate or select the location and/or the number of bytes to remove.

In block 252, the number of bytes selected in block 250 are removed from the byte array 156 at the location selected in block 250.

In block 260, the byte array 156 is saved as the EP 152.

In block 270, the decryption information is saved into the DD 154. In the embodiment illustrated, the decryption information includes the shift amount, the encryption key, the location from which bytes were removed from the byte array 156, and the bytes removed from the byte array 156. Depending upon the implementation details, the decryption information may also include the length of a portion removed from the byte array 156 in block 252 and/or the length of encryption key selected in block 240.

Then, the method 200 terminates.

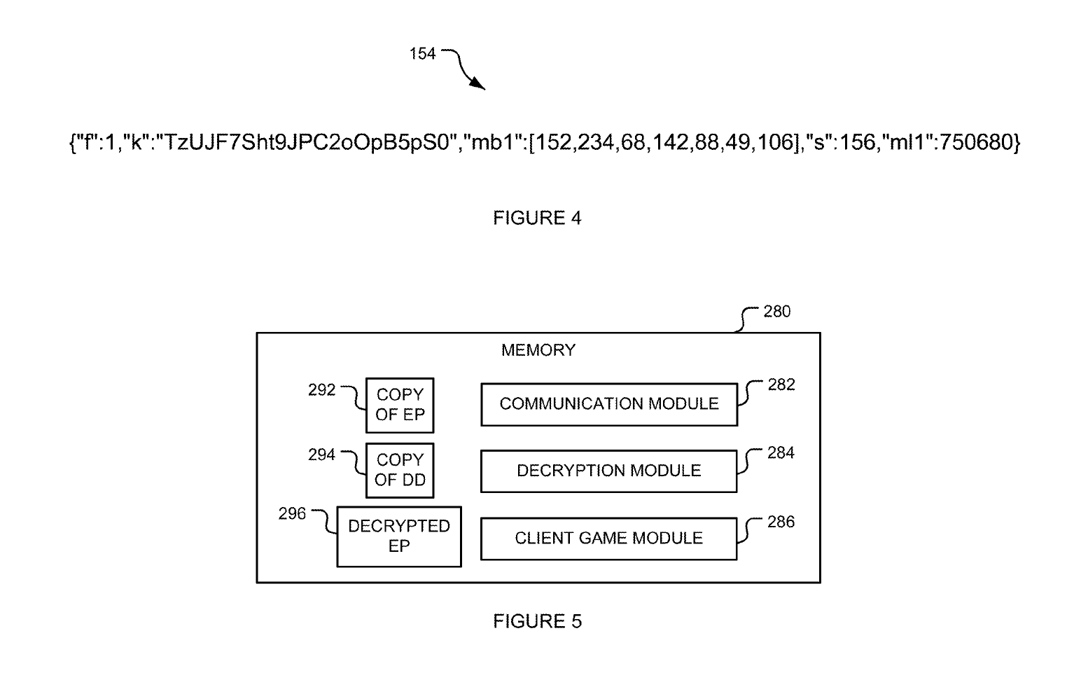

The DD 154 (see FIG. 2) may be implemented using plain text, binary data, and the like. FIG. 4 provides an example of the contents of the DD 154 stored as plain text and formatted using JavaScript Object Notation (“JSON”). As is apparent to those of ordinary skill in the art, in JSON, an object is surrounded by braces. Thus, in FIG. 4, the contents of the DD 154 begin after a first brace “{” and end before a second (closing) brace “}.” Further, in JSON, strings are surrounded by quotation marks. Data is organized into name value pairs where each name is a string (surrounded by quotation marks) followed by a colon, which is followed by a value associated with the name. Name value pairs are arranged in a series and separated by commas. The DD 154 illustrated in FIG. 4 includes the following four name value pairs:

| Name | Value |
|---|---|
| f | 1 |
| k | TzUJF7Sht9JPC2oOpB5pS0 |
| mb1 | 152, 234, 68, 142, 88, 49, 106 |
| s | 156 |
| ml1 | 750680 |

A name “f” is associated with a value that is a number. The value associated with the name “f” is the compression status flag. When (as in FIG. 4) the value associated with the name “f” (the compression status flag) is “1,” the byte array 156 has been compressed. On the other hand, when the value associated with the name “f” (the compression status flag) is “0,” the byte array 156 has not been compressed. A name “k” is associated with a value that is a string surrounded by quotation marks. The value associated with the name “k” is the encryption key. A name “mb1” is associated with a value that is an array of numbers. In JSON, arrays are surrounded by brackets and items in the array are separated by commas. The array of numbers associated with the name “mb1” are the bytes removed from the byte array 156. A name “s” is associated with a value that is a number. The value associated with the name “s” is the shift amount. A name “ml1” is associated with a value that is a number. The value associated with the name “ml1” is the location in the byte array 156 from which the bytes associated with the name “mb1” were removed.

As is apparent to those of ordinary skill in the art, the order of the name value pairs described above may be modified and the DD 154 is not limited to the exemplary order provided above.

By way of another non-limiting example, the DD 154 may include the following names each followed by an appropriate value: flags, key, missing_data_location, missing_data, shift_by, and optionally, hash. As is apparent to those of ordinary skill in the art, the order of the name value pairs may be modified and the DD 154 is not limited to this exemplary order. The name “flags” is associated with a value that is a number. When the value associated with the name “flags” is “1,” the byte array 156 has been compressed. When the value associated with the name “flags” is “2,” a hash function has been formed (e.g., on the source data 150, the byte array 156, and the like) to generate a value. When the value associated with the name “flags” is “4,” an alternate encryption method has been used to encrypt the byte array 156. When the value associated with the name “flags” is “0,” the byte array 156 has not been compressed, the hash function has not been performed, and an alternate encryption method has not been used. The value associated with the name “flags” may be set to “3” to indicate the byte array 156 has been compressed, and the hash function has been performed. The value associated with the name “flags” may be set to “5” to indicate the byte array 156 has been compressed, and an alternate encryption method has been used. The value associated with the name “flags” may be set to “6” to indicate the hash function has been performed, and an alternate encryption method has been used. The value associated with the name “flags” may be set to “7” to indicate the byte array 156 has been compressed, the hash function has been performed, and an alternate encryption method has been used.

The value associated with the name “key” is the encryption key. The name “missing_data” is associated with a value that is an array of numbers. The array of numbers associated with the name “missing_data” are the bytes removed from the byte array 156. The value associated with the name “missing_data_location” is the location in the byte array 156 from which the bytes associated with the name “missing_data” were removed. The value associated with the name “shift_by” is the shift amount. The value associated with the name “hash” is the value generated by the hash function (e.g., performed on the source data 150, the byte array 156, and the like). If the hash function has not been performed, the value associated with the name “hash” may be set to null.

By way of another non-limiting example, the DD 154 may include binary data stored in the following format:

| Byte Number(s) | Data stored in byte(s) |
|---|---|
| Byte 1 | Bit field including compression status flag |
| Byte 2 | Shift amount |
| Byte 3 | Length of portion (bytes) removed from the |
| | byte array 156 |
| Byte 4 | Length of encryption key |
| Byte 5 to Byte “A” | Location from which bytes were removed |
| | from the byte array 156 |
| Byte “B” to Byte “C” | Bytes removed from the byte array 156 |
| Byte “D” to Byte “E” | Encryption key |

By way of a non-limiting example, in the above format, the value of “A” may be eight. In other words, the Byte “A” may be Byte 8. In such embodiments, the Bytes 5 to 8 (storing the location from which bytes were removed from the byte array 156) may be converted into an unsigned integer having a length of four bytes. The value of “B” may be one greater than the value of “A.” The value of “C” may be determined by summing the value stored in Byte 3 and the value of “B.” The value of “D” may be one greater than the value of “C.” The value of “E” may be determined by summing the value stored in Byte 4 and the value of “D.”

By way of a non-limiting example, the bit field of the byte 1 may store a value “0” indicating the byte array 156 has not been compressed, the hash function has not been performed, and an alternate encryption method has not been used. The bit field of the byte 1 may store a value “1” indicating the byte array 156 has been compressed. The bit field of the byte 1 may store a value “2” indicating the hash function has been performed. The bit field of the byte 1 may store a value “3” indicating the byte array 156 has been compressed, and the hash function has been performed. The bit field of the byte 1 may store a value “4” indicating an alternate encryption method has been used to encrypt the byte array 156. The bit field of the byte 1 may store a value “5” indicating the byte array 156 has been compressed, and an alternate encryption method has not been used. The bit field of the byte 1 may store a value “6” indicating the hash function has been performed, and an alternate encryption method has been used. The bit field of the byte 1 may store a value “7” indicating the byte array 156 has been compressed, the hash function has been performed, and an alternate encryption method has been used.

Optionally, the binary format may be modified to store (e.g., at the end of the file after the Byte “E”) the value generated by the hash function (e.g., a hash function performed on the source data 150, the byte array 156, and the like).

As is apparent to those of ordinary skill in the art, the order of the bytes in the binary format described above may be modified and the DD 154 is not limited to the exemplary order provided above.

There are many “portable” data formats (e.g., XML, JSON, BSON, Protocol Buffers, etc.) each with their own pros and cons. Such formats may be used with generic and/or customized binary serializers/deserializers. One problem related to more generic binary serializers/deserializers is how the data is mapped to and from the file (which includes matching the field names in the serialized data to the actual object properties), and how the values are cast (or converted) into proper data types. Such generic binary serializers/deserializers are easy to implement but slow. On the other hand, customized binary serializers/deserializers provide the benefit of speed and size, but may take more time to implement and maintain. Implementations of serializers and deserializers may be constructed for use with the DD 154 (e.g., using the binary format described above) and the EP 152 that are faster than those used with many prior art “portable” data formats because the format of the DD 154 is known to both the serializer (e.g., a serializer included in the encryption module 142) and deserializer (e.g., a deserializer included in the decryption module 284). Thus, these components know what to expect with respect to the EP 152 and the DD 154.

Returning to FIG. 2, the communication module 144 includes instructions that when executed by one or more processors send (e.g., push) the EP 152 and the DD 154 to the client computing devices 120A, 120B, 120C, and 120D. As explained above, the encryption module 142 may be used to create the EP 152 and the DD 154 from the source data 150. Then, the communication module 144 sends the EP 152 to a plurality of recipients (e.g., game players) before a predetermined decryption time (e.g., a start of a game). The communication module 144 waits until the decryption time to send the DD 154 to the recipients who use the DD 154 to decrypt the EP 152.

The communication module 144 may include a scheduler component 158 that determines when the EP 152 and DD 154 are to be sent. The scheduler component 158 may receive instructions from the server game module 146 and/or the sender that include an EP time and/or the decryption time. The EP time is a predetermined time at which the EP 152 is sent to the client computing devices 120A, 120B, 120C, and 120D. The decryption time is a predetermined time at which the DD 154 is sent to the client computing devices 120A, 120B, 120C, and 120D. The decryption time occurs after the EP time.

Alternatively, the sender may manually instruct the communication module 144 to send (e.g., push) the DD 154 to the client computing devices 120A, 120B, 120C, and 120D at the decryption time.

For ease of illustration, the source data 150 will be described as being a game pack that includes a series of game questions and optionally answer choices for each question. In such embodiments, the EP 152 is an encrypted (and optionally compressed) game pack. The server game module 146 includes instructions that when executed by one or more processors receive responses (e.g., answer selections) from the client computing devices 120A, 120B, 120C, and 120D after the game has begun. The server game module 146 may instruct the encryption module 142 to generate the EP 152 and the DD 154 for particular source data (e.g., game pack). The server game module 146 may also instruct the scheduler component 158 of the communication module 144 when to send the EP 152 and/or the DD 154 to the client computing devices 120A, 120B, 120C, and 120D.

The database module 148 includes instructions that when executed by one or more processors implement a database. The database may be configured to store the source data 150, the EP 152, and/or the DD 154 in one or more records. The encryption module 142 may store the EP 152, and/or the DD 154 in the database. The server game module 146 may implement a game registration process whereby each recipient registers for a particular game. In such embodiments, after a recipient registers for a game, the EP for the game is sent to the recipient. Then, at the decryption time (e.g., the start of the game), the communication module 144 obtains the DD for the game from the database and sends the DD for the game to the recipient.

Referring to FIG. 5, as will be described in more detail below, each of the client computing devices 120A, 120B, 120C, and 120D includes a system memory 280 storing data and programming modules. The programming modules each include instructions executable by one or more processors (e.g., the processing unit 21 illustrated in FIG. 8 and described below). The programming modules illustrated in FIG. 5 include a communication module 282, a decryption module 284, and a client game module 286.

The communication module 282 includes instructions that when executed by one or more processors receive a copy 292 of the EP 152 and a copy 294 of the DD 154 from the server computing device 110.

The decryption module 284 includes instructions that when executed by one or more processors use the copy 294 of the DD 154 to decrypt the copy 292 of the EP 152 to produce a decrypted EP 296. The decryption module 284 includes instructions for parsing the copy 294 of the DD 154 and using the parsed information to decrypt the copy 292 of the EP 152.

The client game module 286 includes instructions that when executed by one or more processors display the series of game questions (and optional answer choices) for each question contained in the decrypted EP 296. The client game module 286 is configured to receive responses from a recipient (e.g., player) via a user interface and communicate those responses to the server game module 146 when the game is played.

Because the DD 154 is sent to the client computing devices 120A, 120B, 120C, and 120D to decrypt the EP 152, the encryption method used by the encryption module 142 need only be good enough to prevent the decryption of the EP 152 before the DD 154 is sent. In embodiments in which the EP 152 includes a game pack, this prevents users from decrypting the questions included in the game pack before the game has begun to thereby gain an unfair advantage over other users. Thus, the system 100 may be used to limit cheating.

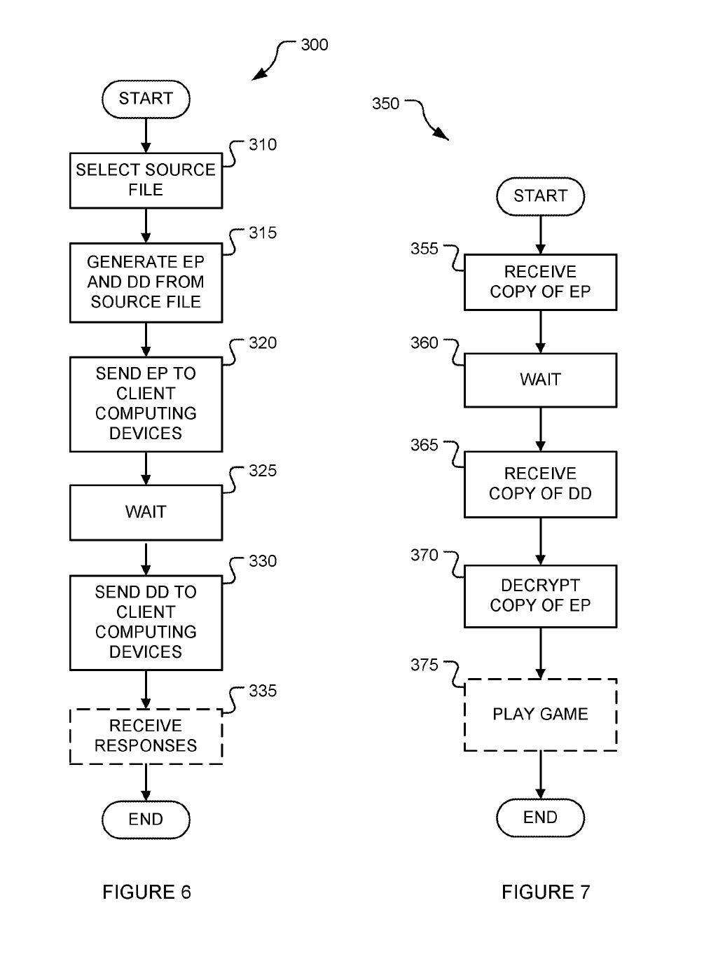

FIG. 6 is a flow diagram of a method 300 performed by the server computing device 110. In first block 310, the source data 150 is selected. By way of a non-limiting example, the server game module 146 may select and/or generate the source data 150. Alternatively, the sender operating the server computing device 110 may select the source data 150.

In next block 315, the encryption module 142 generates the EP 152 and the DD 154. The encryption module 142 may generate the EP 152 and the DD 154 in response from an instruction received from the server game module 146 to do so. Alternatively, the encryption module 142 may generate the EP 152 and the DD 154 in response from an instruction received from the sender (via a user interface) to do so.

In block 320, the communication module 144 sends the EP 152 to the client computing devices 120A, 120B, 120C, and 120D at the EP time. The communication module 144 may send the EP 152 to the client computing devices 120A, 120B, 120C, and 120D in response from an instruction received from the server game module 146 to do so. Alternatively, the communication module 144 may send the EP 152 to the client computing devices 120A, 120B, 120C, and 120D in response from an instruction received from the sender (via a user interface) to do so. Further, the scheduler component 158 may indicate when the EP time has occurred so that the communication module 144 may send the EP 152 to the client computing devices 120A, 120B, 120C, and 120D.

Then, in block 325, the server computing device 110 waits until the predetermined decryption time (e.g., a scheduled start of a game). The scheduler component 158 may be used to determine when the decryption time has occurred. Alternatively, the sender may manually instruct the communication module 144 when to send the DD 154 to the client computing devices 120A, 120B, 120C, and 120D. By way of yet another example, the server game module 146 may instruct the communication module 144 when to send the DD 154 to the client computing devices 120A, 120B, 120C, and 120D.

In block 330, the communication module 144 sends the DD 154 to the client computing devices 120A, 120B, 120C, and 120D.

In optional block 335, the server computing device 110 may receive responses from one or more of the client computing devices 120A, 120B, 120C, and 120D. For example, in block 335, the server game module 146 may receive responses to questions contained in the decrypted EP 296.

Then, the method 300 terminates.

While the method 300 has been described for use with an EP including an encrypted game pack, those of ordinary skill in the art appreciate that the method 300 may be used with other types of encrypted data and the method is not limited to use with game packs. Further, the method 350 may be used for applications unrelated to playing online games and/or televised games. In such embodiments, the server game module 146 may be omitted from the memory 140 (see FIG. 2). Further, the memory 140 may include one or more other modules that select or generate the source data 150, instruct the encryption module 142 to generate the EP 152 and the DD 154, instruct the communication module 144 to send the EP 152 to the client computing devices 120A, 120B, 120C, and 120D, and/or instruct the communication module 144 when to send the DD 154 to the client computing devices 120A, 120B, 120C, and 120D.

FIG. 7 is a flow diagram of a method 350 performed by each of the client computing devices 120A, 120B, 120C, and 120D. For ease of illustration, the method 350 will be described as being performed by the client computing device 120A. However, the method 350 may be performed by any of the client computing devices 120A, 120B, 120C, and 120D or similar computing devices. Further, in embodiments in which the EP 152 includes a game pack, the recipients of the EP 152 may watch a televised game associated with the EP 152 during all or a portion of the performance of the method 350.

In first block 355, the communication module 282 of the client computing device 120A receives the copy 292 of the EP 152 from the server computing device 110.

In block 360, the client computing device 120A waits to receive the copy 294 of the DD 154.

In block 365, the communication module 282 of the client computing device 120A receives the copy 294 of the DD 154.

In block 370, the decryption module 284 of the client computing device 120A decrypts the copy 292 of the EP 152 to produce the decrypted EP 296.

Then, when the decrypted EP 296 includes a game pack, in block 375, the client game module 286 reads the decrypted EP, displays questions (and optionally answer choices) to the recipient, receives responses to the questions, and forwards the responses to the server game module 146.

Then, the method 350 terminates.

While the method 350 has been described for use with an EP including an encrypted game pack, those of ordinary skill in the art appreciate that the method 350 may be used with other types of encrypted data and the method is not limited to use with game packs. Further, the method 350 may be used for applications unrelated to playing online games and/or televised games. In such embodiments, the client game module 286 may be omitted from the memory 280 (see FIG. 5).

The encryption and decryption processes described above may be configured to be very fast. The EP 152 may be configured to be small enough that the time the server computing device 110 waits (in block 325 of the method 300 illustrated in FIG. 6) before sending the DD 154 may small enough to prevent decryption of the EP 152 by a means other than using the DD 154. By way of a non-limiting example, the EP 152 about 10 megabytes (e.g., about 10,485,760 bytes) or less.

### Computing Devices

FIG. 8 is a diagram of hardware and an operating environment in conjunction with which implementations of the server computing device 110, the plurality of client computing devices 120A, 120B, 120C, and 120D, and the network 130 may be practiced. The description of FIG. 8 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 8 includes a general-purpose computing device in the form of a computing device 12. The server computing device 110, and each of the client computing devices 120A, 120B, 120C, and 120D may each be implemented using one or more computing devices like the computing device 12.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The memory 410 (illustrated FIG. 4) may be substantially similar to the system memory 22. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including an operating system 35, one or more application programs 36, other program modules 37, and program data 38. The application programs 36 may include a conventional web browser program configured to display web pages.

A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types physical feedback (e.g., a force feed back game controller).

The input devices described above are operable to receive user input and selections. Together the input and display devices may be described as providing a user interface. The input devices may be used to receive information from the sender, a recipient, and the like. The user interface may be used to display messages (e.g., notifications and alters) to the sender, a recipient, and the like.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 8 include a local-area network (LAN) 51 and a wide-area network (WAN) 52. Such networking environments are commonplace in offices, enterprise-wide computer networks, intranets, and the Internet.

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers and other mobile computing devices may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

In embodiments in which the computing device 12 is implemented as a cellular telephone (e.g., the client computing device 120C illustrated in FIG. 1) or other type of mobile computing device (e.g., the client computing device 120B illustrated in FIG. 1), the computing device 12 may be configured to communicate with a cellular network using a conventional radio (not shown). The cellular network in turn may be connected to one or more other networks (e.g., the Internet).

In embodiments in which the computing device 12 is implemented as an Internet enabled television set (e.g., the client computing device 120D illustrated in FIG. 1), the network 130 may include a cable television network connected to the Internet.

The network 130 (illustrated in FIG. 1) may be implemented using one or more of the networks technologies discussed above.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

Referring to FIG. 2, the memory 140 of the server computing device 110 may be substantially identical to the system memory 22 (see FIG. 8). The memory 140 stores processor executable instructions that when executed by one or more processors cause the one or more processors to perform all or portions of the methods 200 and/or 300.

Referring to FIG. 5, the memory 240 of each of the client computing devices 120A, 120B, 120C, and 120D may be substantially identical to the system memory 22 (see FIG. 8). The memory 280 stores processor executable instructions that when executed by one or more processors cause the one or more processors to perform all or portions of the method 350.

Any of the instructions described above, including the instructions stored by the memory 140 of the server computing device 110 and the memory 280 of each of the client computing devices 120A, 120B, 120C, and 120D, may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

1. A method for use with source data, the method comprising:
shifting the source data in a shift direction by a shift amount to produce shifted source data;
encrypting the shifted source data with an encryption key to produce encrypted shifted source data;
removing a portion of data from a location in the encrypted shifted source data to produce an encryption package; and
generating decryption data comprising the shift amount, the encryption key, an identification of the location in the encrypted shifted source data from which the portion of the data was removed, and the portion of the data removed from the encrypted shifted source data.

2. The method of claim 1, wherein the shift amount is a number of bytes.

3. The method of claim 1 for use with a plurality of remote client computing devices, the method further comprising:
sending a copy of the encryption package to each of the plurality of remote client computing devices; and
after sending the copies of the encryption package to the plurality of remote client computing devices, waiting until a decryption time before sending a copy of the decryption data to each of the plurality of remote client computing devices.

4. The method of claim 3 for use with the plurality of remote client computing devices being configured to decrypt the copy of the encryption package using the copy of the decryption data received by the client computing device, wherein the copy of the decryption data is sent to each of the plurality of remote client computing devices at substantially the same time such that the plurality of remote client computing devices have the opportunity to decrypt the copies of the encryption package at substantially the same time.

5. The method of claim 1, further comprising:
selecting the shift amount using a random or pseudo-random process configured to select a number within a predetermined range.

6. The method of claim 1, further comprising:
selecting the location in the encrypted shifted source data from which the portion of the data is to be removed using a random or pseudo-random process configured to select a number within a predetermined range.

7. The method of claim 1, wherein the portion of the data to be
removed from the location in the encrypted shifted source data comprises a number of bytes, and the method further comprises: selecting the number of bytes using a random or pseudo-random process configured to select a number within a predetermined range.

8. The method of claim 1, further comprising:
compressing the source data before shifting the source data.

9. The method of claim 1, further comprising arranging the source data into a byte array before shifting the source data, wherein the shifted source data is produced by shifting the source data arranged in the byte array;
compressing the byte array before shifting the source data, the decryption data further comprising a flag indicating whether the byte array was compressed; and
storing a value in the flag indicating the byte array was compressed.

10. The method of claim 1, wherein the decryption data comprises fewer than 256 bytes.

11. The method of claim 1, wherein the decryption data comprises 35 bytes to 84 bytes.

12. The method of claim 1, wherein the encryption package is stored in a file comprising fewer than 10 megabytes.

13. The method of claim 1, wherein the shifted source data is encrypted using RC4 encryption.

14. The method of claim 1, wherein the encryption key has a variable length.

15. The method of claim 1, wherein the length of the encryption key varies from 20 bytes to 256 bytes.

16. The method of claim 1, wherein the length of the encryption key varies from 20 bytes to 32 bytes.

17. The method of claim 1, wherein the decryption data further comprises at least one of a length of the encryption key, and a length of the portion of the data removed from the encrypted shifted source data.

18. (canceled)

19. A method performed by at least one server computing device connected to a plurality of client computing devices by at least one network, the method comprising:
sending a copy of an encrypted data file to each of the plurality of client computing devices over the at least one network;
after sending the copies of the encrypted data file, waiting until a predetermined time; and
at the predetermined time, sending decryption data to each of the plurality of client computing devices over the at least one network, the decryption data being configured to be received by the plurality of client computing devices at substantially the same time, the decryption data comprising information usable by each of the plurality of client computing devices to decrypt the copy of the encrypted data file sent to the client computing device, the information comprising a shift amount, an encryption key, an identification of a location from which a portion of the data was removed from the copies of the encrypted data file, and the portion of the data that was removed.

20. A method performed by at least one server computing device connected to a plurality of client computing devices by at least one network, the method comprising:
sending a copy of an encrypted data file to each of the plurality of client computing devices over the at least one network, the copy of the encrypted data file comprising a plurality of questions;
after sending the copies of the encrypted data file, waiting until a predetermined time;
at the predetermined time, sending decryption data to each of the plurality of client computing devices over the at least one network, the decryption data being configured to be received by the plurality of client computing devices at substantially the same time, the decryption data comprising information usable by each of the plurality of client computing devices to decrypt the copy of the encrypted data file sent to the client computing device; and
receiving responses to the plurality of questions after sending the decryption data to each of the plurality of client computing devices.

21. A method for use with a source file comprising bytes of data, the method comprising:
placing the bytes of data of the source file in a byte array;
compressing the bytes of data in the byte array to produce a compressed byte array;
shifting the bytes of data in the compressed byte array in a shift direction by a shift amount to produce a shifted byte array;
encrypting the shifted byte array with an encryption key to produce an encrypted byte array;
removing a portion from the encrypted byte array to produce an incomplete byte array, the portion having been removed from a location in the encrypted byte array;
storing the incomplete byte array as an encryption package; and
storing decryption data comprising the shift amount, the encryption key, an identification of the location in the encrypted byte array, and the portion removed from the encrypted byte array.

22. The method of claim 21, wherein the decryption data further comprises at least one of a length of the portion removed from the encrypted byte array and a length of the encryption key.

23. The method of claim 21, wherein the decryption data further comprises a flag indicating whether the bytes of data in the byte array were compressed, and the method further comprises storing a value in the flag indicating the bytes of data in the byte array were compressed.

24. A computing system comprising at least one server computing device connected to a plurality of remote client computing devices, the at least one server computing device being configured to:
shift source data in a shift direction by a shift amount to produce shifted source data, the source data comprising information;
encrypt the shifted source data with an encryption key to produce encrypted shifted source data;
remove a portion of the data from a location in the encrypted shifted source data to produce an encryption package;
generate decryption data comprising the shift amount, the encryption key, an identification of the location in the encrypted shifted source data from which the portion of the data was removed, and the portion of the data removed from the encrypted shifted source data;
send a copy of the encryption package to each of the plurality of remote client computing devices; and
send a copy of the decryption data to each of the plurality of remote client computing devices at a decryption time occurring after the copies of the encryption package are sent to the plurality of remote client computing devices, each of the plurality of remote client computing devices being configured to decrypt the copy of the encryption package using the copy of the decryption data received by the client computing device to substantially simultaneously obtain the information of the source data.

25. The computing system of claim 24, wherein the at least one server computing device is further configured to receive responses from the plurality of remote client computing devices.
